(19) United States
(12) Patent Application Publication
(10) Pub. No.: US 2007/0210623 A1
(43) Pub. Date: Sep. 13, 2007

(54) Panorama roof

(76) Inventors: Thomas Becher, Rodgau (DE); Horst Boehm, Frankfurt/Main (DE); Rainer Grimm, Frankfurt/Main (DE); Joachim Roeder, Muehlheim (DE); Claudia Riess, Lichtenberg (DE); Manfred Roehnke, Roedermark (DE)

Correspondence Address: CARLSON, GASKEY & OLDS, P.C., 400 WEST MAPLE ROAD, SUITE 350, BIRMINGHAM, MI, 48009, US

(21) Appl. No.: 11/714,965

(22) Filed: Mar. 7, 2007

(30) Foreign Application Priority Data
Mar. 13, 2006 (EP) 06 005 051.5

(51) Int. Cl. B60J 7/043

(52) U.S. Cl. 296/216.03

(57) ABSTRACT

A sliding roof system includes a cover adapted to be moved rearwardly above a roof element, a guide rail, and a front raising mechanism that raises a front edge of the cover outwardly. A rear raising mechanism raises a rear edge of the cover outwardly, and is coupled with the front raising mechanism.

### RELATED APPLICATIONS

The application claims priority to European Patent No. 06 005 051.5, which was filed on Mar. 13, 2006.

### BACKGROUND OF THE INVENTION

The invention relates to a sliding roof system comprising a cover adapted to move rearward above a roof element, a guide rail, and a front raising mechanism with which a front edge of the cover can be raised outwards.

A sliding roof system of this type is typically part of a panorama roof in which both the cover and the roof element are made of transparent plastic or glass. The roof element may either be immovably attached to a car body or a roof, or could be configured such that the roof element can be raised or moved. Also, it is possible that the cover will be raised outwards only at a rear edge, so that the cover assumes a so-called venting position, or the cover could be completely moved outwards and then to the rear, so that the cover lies above the roof element. In this condition an opening, which otherwise is closed by the cover, is exposed by the roof element to a greater or lesser extent.

If the cover is to be brought to the rear above the roof element, there arises the problem of how to hold the cover in an open position. It is not possible to use a complex guide at the rear edge of the cover, which is situated above the roof element when the cover is retracted, because this type of guide would have to be connected with a guide rail underneath the roof element. This is why there are attempts to arrange the entire raising mechanism for the cover in a region of a front edge only. In this configuration, the raising mechanism will always stay in front of the roof element, i.e. in an area which is freely accessible when the cover is open. The problem is that a comparably stable and, for this reason, even a large raising mechanism is required if all the loads acting on the open cover during use can only be supported at the front edge of the cover. Such a raising mechanism needs a certain space, which limits a traverse path of the cover to the rear. Finally, a maximum displacement of the cover to the rear is limited by dimensions of the raising mechanism; the rear edge of the raising mechanism cannot be moved to be located behind the front edge of the roof element.

There are solutions in which a spring-loaded supporting lever is used at the rear edge of the cover. This lever diverts a portion of the loads that act on the raised cover, into a guide rail underneath the roof element, and thereby slightly relieves the front raising mechanism. Nevertheless, the front raising mechanism has to be designed to be comparably massive with this solution, too.

It is the object of the invention to provide a sliding roof system of the type initially mentioned where in a region of the front edge of the cover, a raising mechanism is used that is comparably filigree and, for this reason, has a short construction.

### SUMMARY OF THE INVENTION

The subject invention provides a rear raising mechanism that can raise a rear edge of a cover outwardly, and which is coupled with a front raising mechanism. The invention is based on a fundamental idea to concentrate an actual coupling of the cover with a drive for the cover, i.e. the raising mechanism, essentially in a region of a front edge of the cover. At the same time, the rear raising mechanism is used at the rear edge of the cover to raise this rear edge in a defined manner. Through the employment of front and rear raising mechanisms, it is possible to calculate very precisely the loads that will act on each raising mechanism. The front and rear raising mechanisms therefore can be designed in a very precise manner, and it is possible to use slender raising mechanisms which need little space. Particularly, the front raising mechanism can have a short construction, which allows the cover to be moved very far across the roof element.

Advantageous embodiments of the invention will be apparent from the sub-claims.

These and other features of the present invention can be best understood from the following specification and drawings, the following of which is a brief description.

### BRIEF DESCRIPTION OF THE DRAWINGS

FIG. 1 is a perspective view of a vehicle roof comprising a sliding roof system with a cover in a partially open position.

FIG. 2 is a schematic side view of the sliding roof system with the cover in a closed position.

FIG. 3 is a view corresponding to that of FIG. 2, with the cover being in a fully open position moved to the rear.

FIG. 4 shows a section along plane IV-IV of FIG. 2.

FIG. 5 shows in a perspective view some components of the sliding roof system.

FIG. 6 shows in a perspective view some components of a rear raising mechanism.

FIG. 7 shows in a first perspective view a cover support with the components of the rear raising mechanism that are attached to the cover support.

FIG. 8 shows the components of FIG. 7 in a further perspective view.

FIG. 9 shows the rear raising mechanism in a further perspective view.

### DETAILED DESCRIPTION OF THE PREFERRED EMBODIMENT

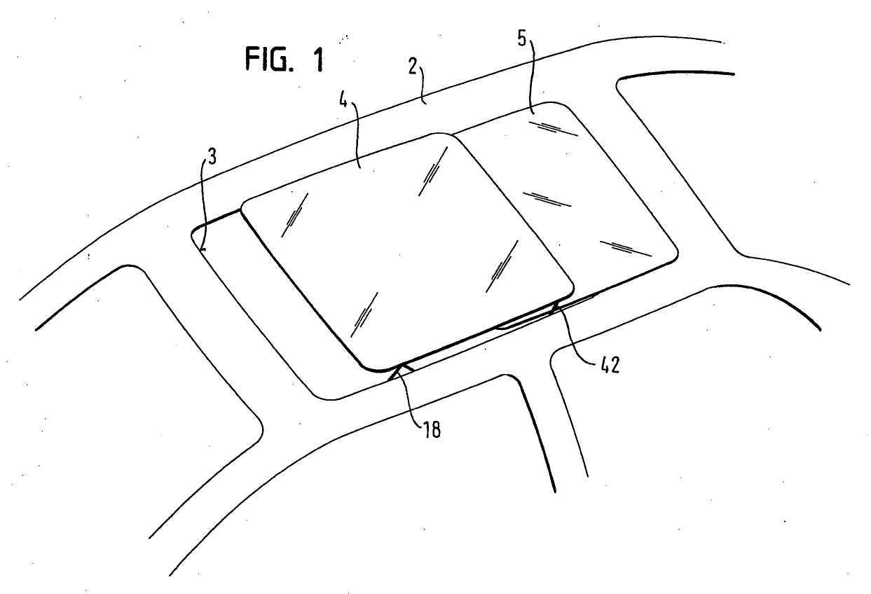

FIG. 1 shows a vehicle roof 2 in which an opening 3 for a cover 4 is formed. A roof element 5 is arranged behind the cover 4. The cover 4 and the roof element 5 are comprised of a transparent material, in particular plastic or glass.

As far as terms such as “top”, “front” or the like are used for the explanation of a sliding roof system, it is referred to the usual terminology concerning a vehicle. Thus, “front” means in a direction of travel, and “top” designates a direction facing away from the wheels.

The sliding roof system has two guide rails 10 extending along edges of the opening 3 as far as to underneath the roof element 5. As the sliding roof system is constructed to be mirror-inverted with reference to a middle longitudinal axis of a vehicle, only one side of the sliding roof system will be described in the following.

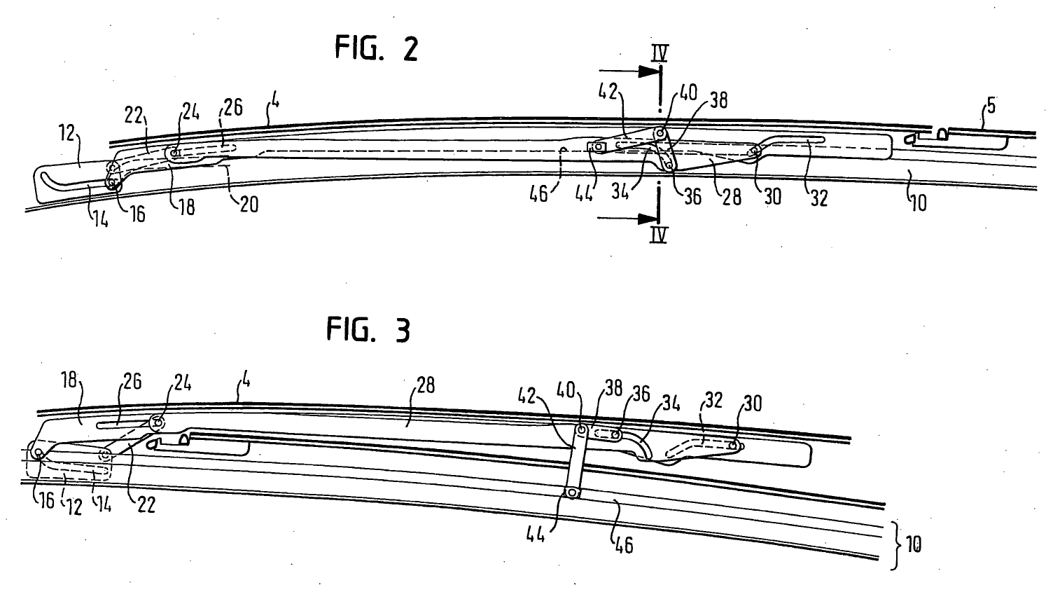

A carriage 12 can be shifted in the guide rail 10 by a drive cable (not shown) that is guided to be resistant to tensile forces and bending, and by a drive motor (not shown) in the guide rail 10. The carriage 12 has a lifting slot 14, which starting from the rear at first extends slightly upwards, and in a front region of the carriage 12 extends somewhat steeper in an upward direction. The lifting slot 14 is engaged by a lifting pin 16, which together with the lifting slot 14, forms a lifting slot guide. The lifting pin 16 is firmly attached to a cover support 18 to which the cover 4 is mounted. The lifting pin 16 furthermore engages a slide guide track 20, which is indicated in FIG. 2 in broken lines, and is firmly attached in the guide rail 10. The slide guide track 20 has at a front end a comparably steeply ascending portion and following thereto a portion that extends to the rear parallel to the direction of extension of the guide rail 10.

Pivotally coupled with the carriage 12 is a lever 22 that engages a sliding motion slot 26 on the cover support 18 with a sliding pin 24. Together with the sliding motion slot 26, the sliding pin 24 forms a swivel motion slot guide. Coupled with the sliding pin 24 is a push bar 28 that extends along the cover support 18 starting from the sliding pin 24 to the rear. The push bar 28 has a rear end provided with a conversion pin 30 that engages a conversion slot 32 on the cover support 18. The conversion pin 30 together with the conversion slot 32 forms a conversion slot guide. As seen from the front to the rear, the conversion slot 32 firstly extends obliquely upwards and then horizontally to the rear.

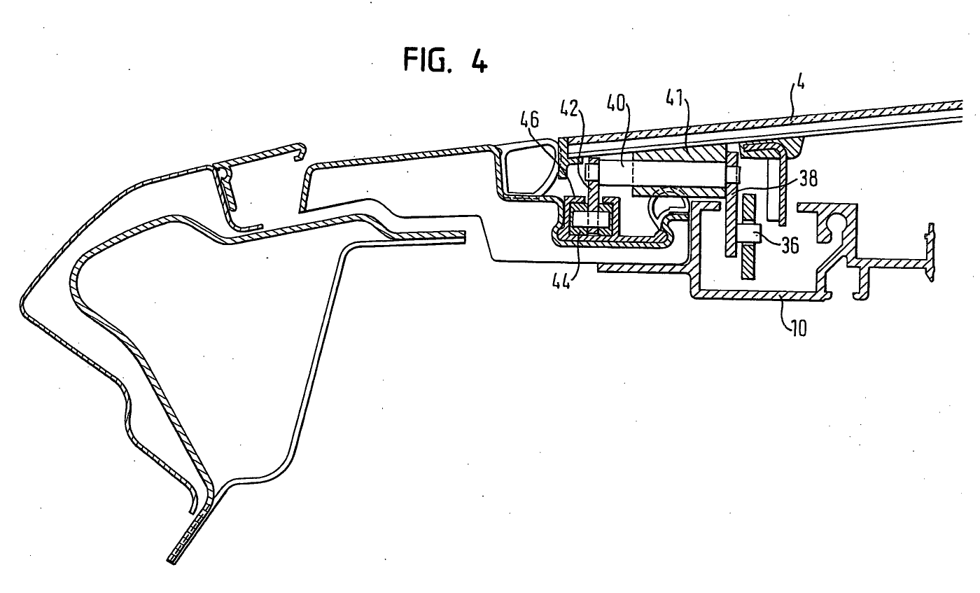

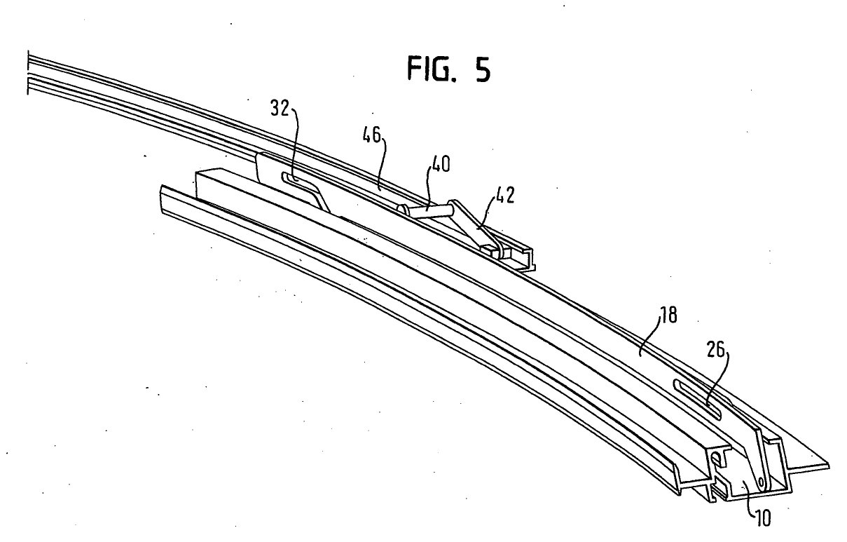

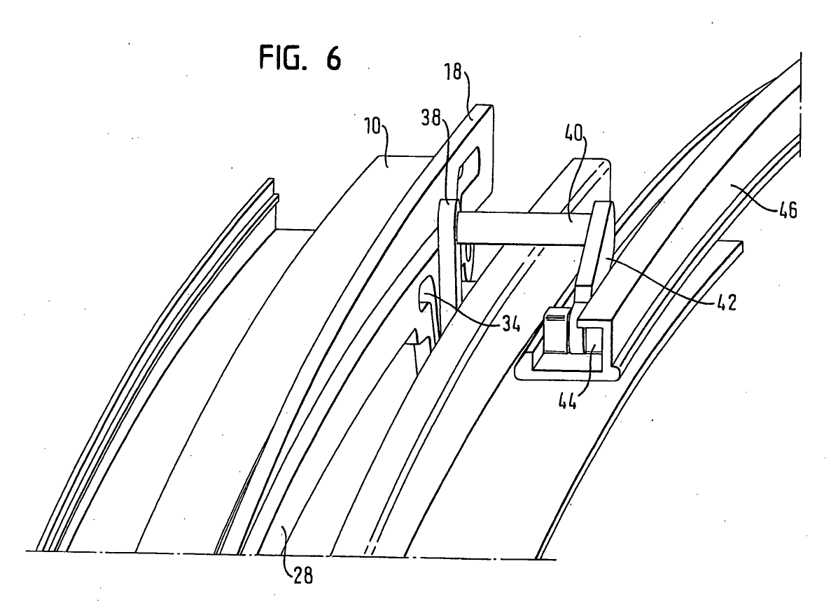

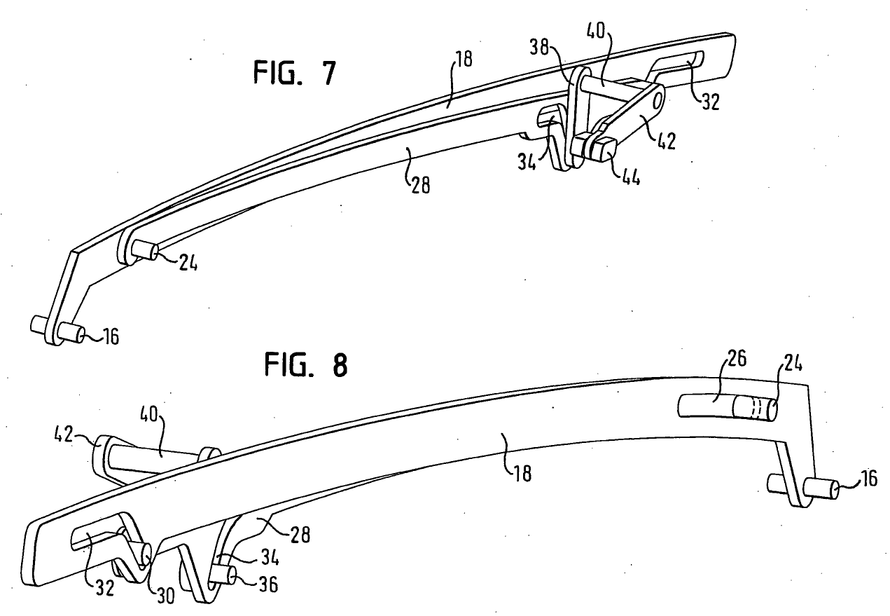

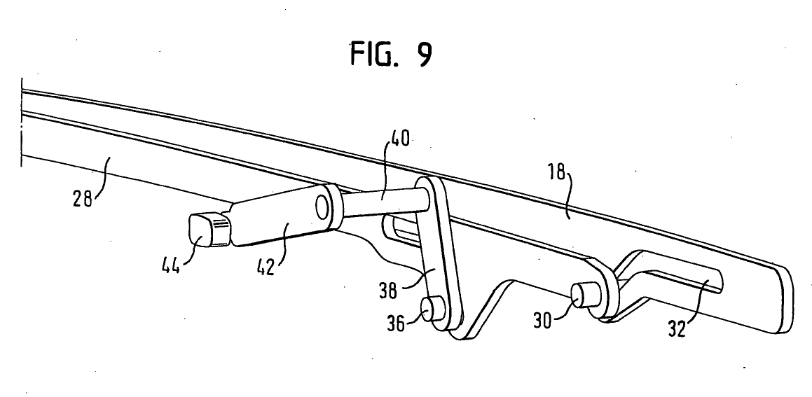

Shortly in front of the rear end of the push bar 28 that engages in the conversion slot 32, the push bar 28 has a swivel motion slot 34 which, as seen from the front to the rear, first extends straight to the rear and then runs downward in an oblique direction. The swivel motion slot 34 is engaged by a pivot pin 36, which together with the swivel motion slot 34, forms a swivel motion slot guide. The pivot pin 36 is attached to a swiveling lever 38 which has an end facing away from the pivot pin 36 attached to a shaft 40. The shaft 40 is rotatably supported on the cover 4 or on an element connected with the cover 4. This is indicated in FIG. 4 by a bearing block 41.

Also connected with the shaft 40 is a raising lever 42, which is rotated relative to the swiveling lever 38 by approximately 90°. An end of the raising lever 42 facing away from the shaft 40 is provided with a sliding piece 44 that is firmly guided in a vertical direction in a raising track 46, but can be moved in longitudinal direction. The raising track 46 may be part of the guide rail 10 or an element affixed to the guide rail 10. In particular, the raising track 46 may be arranged as a separate element in a wet zone, while the guide rail 10 is arranged in a dry zone.

In an initial position (see all Figures except for FIGS. 1 and 3) in which the cover 4 is closed, the carriage 12 has moved to the front to a maximum extent. The lifting pin 16 is located at the rear, lower end of the lifting slot 14 and at the front, lower end of the slide guide track 20. Thus, the front edge of the cover 4 is blocked both in the longitudinal and vertical direction.

Due to the coupling between the carriage 12 and the push bar 28 via the lever 22, the push bar 28 is in a forward position in which the sliding pin 24 is situated at the front end of the sliding motion slot 26. At the same time the conversion pin 30 is situated at the front, lower end of the conversion slot 32.

Thereby the pivot pin 36 is located at the rear, lower end of the swivel motion slot 34, so that the raising lever 42 assumes an approximately horizontal position. With the raising lever 42, which on the one hand engages in the raising track 46 with the sliding piece 44, and on the other hand, is secured on the cover 4 by the shaft 40, even the rear edge of the cover 4 is blocked in the vertical direction.

When the cover 4 is to be opened, the carriage 12 is moved to the rear in the guide rail 10. By this process, the lifting pin 16 initially moves in an upward direction by a slight distance only, whereby the front edge of the cover 4 only performs a slight movement in the upward direction and to the rear. The lever 22, however, shifts the push bar 28 relative to the cover support 18 to the rear. On the one hand, this has the effect that the conversion slot guide pushes the rear area of the push bar 28 in the upward direction. This results in the pivot pin 36 being moved to the rear and to the top. On the other hand, the displacement of the push bar 28 has the effect that the swivel motion slot 34 moves relative to the shaft 40, so that the pivot pin 36 in the swivel motion slot 34 is further shifted to the rear and to the top. In the illustration of FIGS. 2 and 3, the swiveling lever 38 performs a counter-clockwise movement. This results in the raising lever 42 also being moved in a counter-clockwise direction. Such rotation causes the cover 4 to be raised upwards because the raising lever 42 rests at a lower end via the sliding piece 44 against the raising track 46. The raising movement of the rear edge of the cover 4 is finished before the lifting slot 14 has moved the lifting pin 16 upwards to such an extent that the lifting pin 16 enters the part of the slide guide track 20 that extends straight to the rear, and the cover 4 can be entrained to the rear by the carriage 12. The cover 4 will then be moved to the rear outside the roof element 5 and above the roof element 5.

If the cover 4 is to be closed again, the carriage 12 is shifted to the front, with the entire motion sequence proceeding in the reverse order.

The special advantage of the sliding roof system which has been described is that the rear edge of the cover 4 is supported on the roof solely by the raising lever 42, which has a very slim construction. This narrow raising lever 42 can easily be moved along a sealing in the slot, which is provided laterally alongside the roof element 5. Due to the forced coupling with the front raising mechanism, in particular formed by the lifting slot guide and the carriage 12, the rear raising mechanism is able to be controlled and operated in a very precise manner.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A sliding roof system comprising:
a cover adapted to be moved rearwardly above a roof element;
a guide rail;
a front raising mechanism that raises a front edge of the cover outwardly; and
a rear raising mechanism that raises a rear edge of the cover outwardly, and which is coupled with the front raising mechanism.

2. The sliding roof system according to claim 1, wherein the rear raising mechanism has a raising lever that is supported on the cover and rests upon the guide rail.

3. The sliding roof system according to claim 2, wherein the raising lever is coupled with a swiveling lever, which in turn is coupled with the front raising mechanism.

4. The sliding roof system according to claim 3, wherein the swiveling lever and the raising lever are non-rotatably attached to a shaft that is rotatably supported on the cover.

5. The sliding roof system according to claim 3, wherein the swiveling lever is coupled with a push bar supported on a cover support that is movable in the guide rail.

6. The sliding roof system according to claim 5, wherein the swiveling lever is coupled with the push bar with a swivel motion slot guide.

7. The sliding roof system according to claim 5, wherein the push bar is coupled in a region of the rear raising mechanism with the cover support with a conversion slot guide.

8. The sliding roof system according to claim 5, including a carriage that is movable in the guide rail, wherein the push bar is coupled with the carriage with a lever.

9. The sliding roof system according to claim 8, wherein the cover support is coupled with the carriage with a lifting slot guide.

10. The sliding roof system according to claim 5, wherein the push bar is connected at a front end with the cover support with a sliding guide.
